(19) United States
(12) Patent Application Publication
(10) Pub. No.: US 2013/0324191 A1
(43) Pub. Date: Dec. 5, 2013

(54) EXTERNAL ELECTRONIC DEVICE AND METHOD FOR WIRELESSLY ACCESSING STORAGE DEVICE

(71) Applicant: Hsin-Yu Chen, New Taipei City (TW)

(72) Inventor: Hsin-Yu Chen, New Taipei City (TW)

(21) Appl. No.: 13/717,713

(22) Filed: Dec. 18, 2012

Related U.S. Application Data
(60) Provisional application No. 61/652,825, filed on May 29, 2012.

(51) Int. Cl. H04M 1/725

(52) U.S. Cl. CPC H04M 1/7253
USPC 455/557

(57) ABSTRACT

An external electronic device and a method for wirelessly accessing a storage device are provided. The external electronic device includes a peripheral connection interface, a communication unit and an operation interface unit. The peripheral connection interface is connected with a storage device with a corresponding connecting interface. The communication unit is coupled to the peripheral connection interface and configured for communicating with a communication device via a wireless transmission protocol. The operation interface unit is coupled to the peripheral connection interface and the communication unit and has a webpage operation interface, ios application operational interface, and/or android application operation interface related to the storage device. The external electronic device provides the communication device an access service to the storage device through the webpage operation interface, ios application operation interface, and/or android application operation interface.

### CROSS-REFERENCE TO RELATED APPLICATION

This application claims the priority benefits of U.S. provisional application Ser. No. 61/652,825, filed on May 29, 2012. The entirety of the above-mentioned patent applications is hereby incorporated by reference herein and made a part of this specification.

### BACKGROUND

1. Field of the Invention

The invention relates to a digital resource sharing technology, and more particularly to, an external electronic device for providing a wireless access service, and a method for wirelessly accessing a storage device.

2. Description of Related Art

Following the development of peripheral connection interfaces, such as universal serial bus (USB) specifications, likewise similar competitive standards and counterparts such as “Firewire”, and the more recent “Light Peak”, also known as “Thunderbolt”, and the rise of Flash Drives, the portable Flash Drives have become one of the digital indispensable products for modern people. The advent of the flash drives has also driven storage medias such as 3.5 inches floppy disk and compact disc to become miniaturized respectively due to small capacity, data update inconvenience and other shortcomings As long as a host computer possess a transmission interface compatible with Flash Drive products, both writing data into the flash drive or reading information within the flash drive are very convenient, and a portability of the data are also greatly improved. For this reason, users are increasingly accustomed to use the flash drive to store all kinds of information, and thus are capable of processing data on a private or public host computer. When larger capacity was needed, the Hard disc drives was made portable and marketed as Portable HDD and or Portable Hard Drives, which comes in many form factors. The capacity of these Portable Hard Drives can vary from unit to unit, but they can even surpass the storage capacity of a regular user's computer.

Generally, if it is needed to access data or contents within the flash drive, the Flash Drive must be connected to, for example, a personal computer, laptop or computing device, which posses a peripheral connection interface (e.g., a universal serial bus interface, a Firewire interface, or a Light Peak interface). Nevertheless, if a Smartphone, a tablet PC and other mobile devices which do not posses the peripheral connection interface (e.g., universal serial bus interface, Firewire interface, or Light Peak interface), and want to access the data within the flash drive, currently, it can only be done through using the computing device to interconvert the data between the flash drive and the mobile devices, thus resulting an inconvenience of use for the users.

### SUMMARY OF THE INVENTION

The invention provides an external electronic device and a method for wirelessly accessing a storage device, such that the external electronic device, after connected to a storage device with a peripheral connection interface (e.g., a universal serial bus, a Firewire, or a Light Peak) may provide a mobiles device a wireless access service to the storage device.

The invention provides an external electronic device including a peripheral connection interface, a communication unit and an operation interface unit. The peripheral connection interface is connected to a storage device with a corresponding connecting interface. The communication unit is coupled to the peripheral connection interface and configured for communicating with a communication device via a wireless transmission protocol. The operation interface unit is coupled to the peripheral connection interface and the communication unit, wherein the operation interface unit has a webpage operation interface, ios application interface, and/or android application operation interface related to the storage device. Wherein, the external electronic device provides the communication device an access service to the storage device through the webpage operation interface, ios application operation interface, and/or android application operation interface.

In an embodiment of the invention, the wireless transmission protocol includes a Third Generation mobile telecommunication “3G” protocol, a Fourth Generation mobile telecommunication “4G” protocol, a Bluetooth protocol, a Wireless Fidelity certification protocol, or a wireless local area network protocol.

In an embodiment of the invention, the external electronic device further includes a change-over switch coupled to the communication unit, and the change-over switch is used for switching the wireless transmission protocol.

In an embodiment of the invention, the external electronic device further includes a power supply unit coupled to the peripheral connection interface for providing an operational power supply to the storage device.

In an embodiment of the invention, the external electronic device further includes a certification unit coupled to the operation interface unit for certifying the communication device to verify that the communication device has a permission for performing an access operation.

In another point of view, the invention provides a method for wirelessly accessing a storage device, suitable for an external electronic device, comprising the following steps. Firstly, connecting to a storage device via a peripheral connection interface. Next, using a wireless transmission protocol to communicate with a communication device via a communication unit. Then, providing the communication device an access service to the storage device through a webpage operation interface, ios application operation interface, and/or android application operation interface in an operation interface unit related to the storage device.

In an embodiment of the invention, before the step of using the wireless transmission protocol to communicate with the communication device via the communication unit, a step of switching the wireless transmission protocol via a change-over switch is further included.

In an embodiment of the invention, after the step of connecting to the storage device via the peripheral connection interface, a step of providing an operational power supply for the storage device via a power supply unit is further included.

In an embodiment of the invention, before the step of providing the communication device the access service to the storage device through the operation interface unit, a step of certifying the communication device via a certification unit to verify that the communication device has a permission for performing an access operation s further included.

In an embodiment of the invention, the access service includes read, edit, delete, and save data of the storage device.

According to the foregoing, the invention provides the external electronic device and the method for wireless accessing the storage device. In an embodiment of the invention, after the external electronic device is connected to the corresponding connecting interface with the storage device, the communication device may use a wireless transmission protocol to communicate with each other via the wireless transmission interface established by the external electronic device, and may perform accessing and data management to a folder or a document within the storage device through the webpage operation interface. Therefore, a document transmission between the storage device and the communication device does not require any additional wiring connection, such that the communication device has more convenience when accessing the data within the storage device.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a block diagram of establishing a wireless transmission between a storage device and a communication device via an external electronic device according to a first embodiment.

FIG. 1B schematically illustrates a flow chart diagram of providing a wireless access service via an external electronic device according to a first embodiment.

FIG. 2A illustrates a block diagram of establishing a wireless transmission between a storage device and a communication device via an external electronic device according to a second embodiment.

FIG. 2B schematically illustrates a flow chart diagram of providing a wireless access service via an external electronic device according to a second embodiment.

FIG. 3A illustrates a block diagram of establishing a wireless transmission between a storage device and a communication device via an external electronic device according to a third embodiment.

FIG. 3B illustrates a flow chart diagram of providing a access service via an external electronic device 300 according to a third embodiment.

FIGS. 4A to 4C illustrate schematic structural diagram of an external electronic device and a storage device.

### DETAILED DESCRIPTION OF DISCLOSED EMBODIMENTS

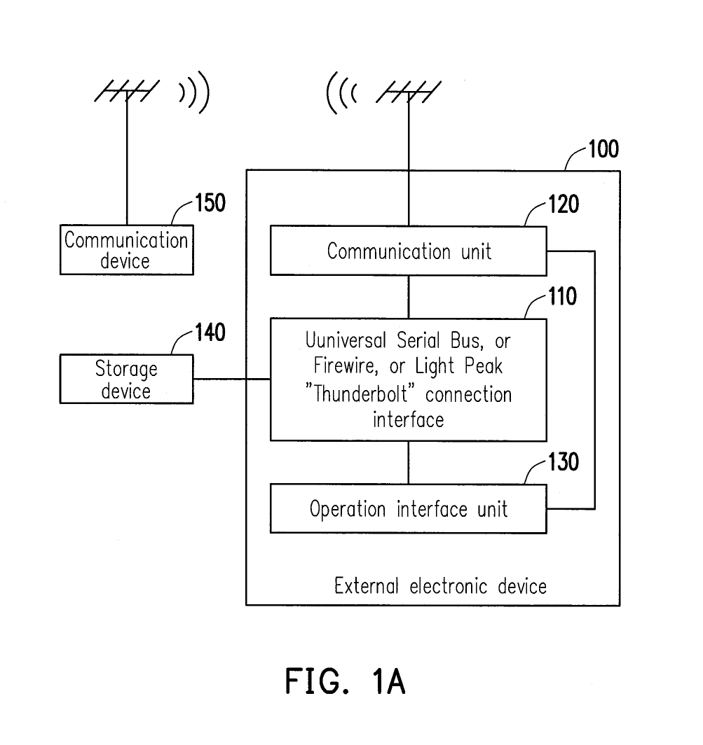

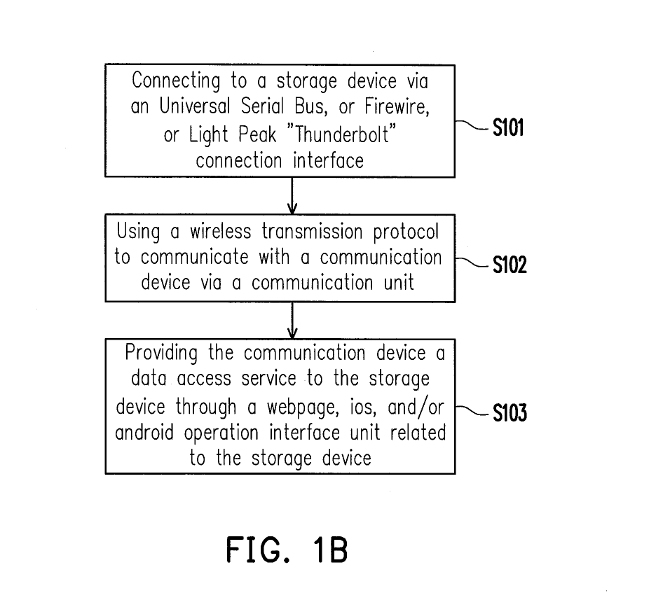

FIG. 1A illustrates a block diagram of establishing a wireless transmission between a storage device and a communication device via an external electronic device according to a first embodiment. In the present embodiment, an external electronic device 100 includes an universal serial bus, or firewire, or Light Peak “Thunderbolt” connection interface 110, a communication unit 120 and an operation interface unit 130. The universal serial bus, or firewire, or Light Peak “Thunderbolt” connection interface 110 is connected to a storage device 140 with a corresponding connection interface (e.g., a universal serial bus, or a Firewire, or a Light Peak). In the present embodiment, the storage device 140 may be a flash drive, a solid state disc (SSD), and external hard drive, a recording pen, and so forth, but is not limited thereto. The universal serial bus, or firewire, or Light Peak “Thunderbolt” connection interface 110 and the corresponding connection interface described above can be hardware interfaces with a protocol of universal serial bus (USB), Firewire, or Light Peak, and so forth, but is not limited thereto.

The communication unit 120 is coupled to the universal serial bus, or firewire, or Light Peak “Thunderbolt” connection interface 110 for communicating with a communication device 150 via a wireless transmission protocol. The wireless transmission protocol may be a Third Generation mobile telecommunication “3G” protocol, a Forth Generation mobile telecommunication “4G” protocol, a Bluetooth protocol, a wireless fidelity (Wi-Fi) certification protocol, a wireless local area network protocol (such as IEEE 802.11a, 802.11b, 802.11g, 802.11n, and 802.11ac), and so forth. Users may select the wireless transmission protocol for the communication unit 120 in the external electronic device 100 according to wireless accessories or related requirements of the communication device 150.

The communication device 150 may be a Smartphone, a laptop, a tablet PC, a personal digital assistant (PDA), and other electronic devices with a function of wireless transmission. Therefore, an implementation of the wireless transmission protocol for an application of the present embodiment is not limited to the abovementioned disclosure.

In FIG. 1A, the operation interface unit 130 is coupled to the universal serial bus, or firewire, or Light Peak “Thunderbolt” connection interface 110 and the communication unit 120. The operation interface unit 130 has a webpage operation interface related to the storage device 140. In other words, after the external electronic device 100 is connected to the storage device 140, the operation interface unit 130 may use the webpage operation interface to display a configuration condition of a folder or a document stored within the storage device 140 and to perform a corresponding action such as data accessing, data management and so forth. The webpage operation interface of the present embodiment may use JAVA programming language, hyper text markup language (HTML) and so forth to write a graphical user interface, so that the communication device 150 of multiple types can use the webpage operation interface in cross platform. The ios and android application operation interface will utilize corresponding programming language of each unique operating system.

FIG. 1B schematically illustrates a flow chart diagram of providing a wireless access service via an external electronic device according to the first embodiment, the following uses the device structure of FIG. 1A in combination with the flow chart diagram of FIG. 1B to describe, in detail steps, a method for the external electronic device 100 to provide the wireless access service to the communication device 150.

Firstly, when the communication device 150 of the users wants to perform the wireless access service to the storage device 140 through the external electronic device 100, the external electronic device 100 may be connected to the storage device 140 via the universal serial bus, or firewire, or Light Peak “Thunderbolt” connection interface 110 and the corresponding connecting interface of the storage device 140 (step S101). After the external electronic device 100 is connected to the storage device 140, the external electronic device 100 then can be informed of a data storage condition of the storage device 140 via the universal serial bus, or firewire, or Light Peak “Thunderbolt” connection interface 110 and be prepared for accessing the storage device 140. On the other hand, the operation interface unit 130, at this moment, is to prepare and get the webpage operation interface ready. Then, the users can operate the communication device 150, and use the wireless transmission protocol to communicate with the communication device 150 via the communication unit 120 in the external electronic device 100 (step S102). Noteworthily, if the wireless transmission protocol adopts, for example, a 3G or 4G mobile telecommunication protocol, the external electronic device 100 is additionally requiring, for example, a design of a subscriber identification module (SIM) card slot in order to use the SIM card, which is capable of providing a mobile internet service, to achieve a function of communication with the communication device 150.

Next, since the operation interface unit 130 has the webpage operation interface related to the storage device 140, the users may uses the communication device 150 to remote control the webpage operation interface in the operation interface unit 130, so that the external electronic device 100 may provide the communication device 150 a data access service (e.g., reading, editing, deleting, and saving of the document and the folder) to the storage device 140 through the webpage operation interface, ios, and/or android operation interface unit (step S103).

Simply, if the storage device 140 (e.g., external drive) cannot be connected with the communication device 150 (e.g., Smartphone) using a wired transmission, the users may use the USB, Firewire, or Light Peak interface to connect the universal serial bus, or firewire, or Light Peak “Thunderbolt” connection interface 110 of the external electronic device 100 and the corresponding connecting interface of the storage device 140 with each other, and then connect together the communication device 150 and the external electronic device 100 by mutually exploiting the wireless transmission protocol, so that the communication device 150 may access, for example, the folder or the document within the storage device 140 through the webpage operation interface. Therefore, a document transmission between the storage device 140 and the communication device 150 may not require any additional wiring connection, such that the communication device 150 has more convenience when accessing the data within the storage device 140.

In another embodiment, the external electronic device 100, after connected to the storage device 140, may emit a broadcast signal so as to inform a nearby electronic device that a storage device (viz. the storage device 140) in the surrounding is amiable for accessing. For example, if the wireless transmission protocol is a Bluetooth communication protocol, the nearby electronic device, through searching a nearby Bluetooth device, may find the broadcast signal of the external electronic device 100 and perform a pairing for communicating with each other.

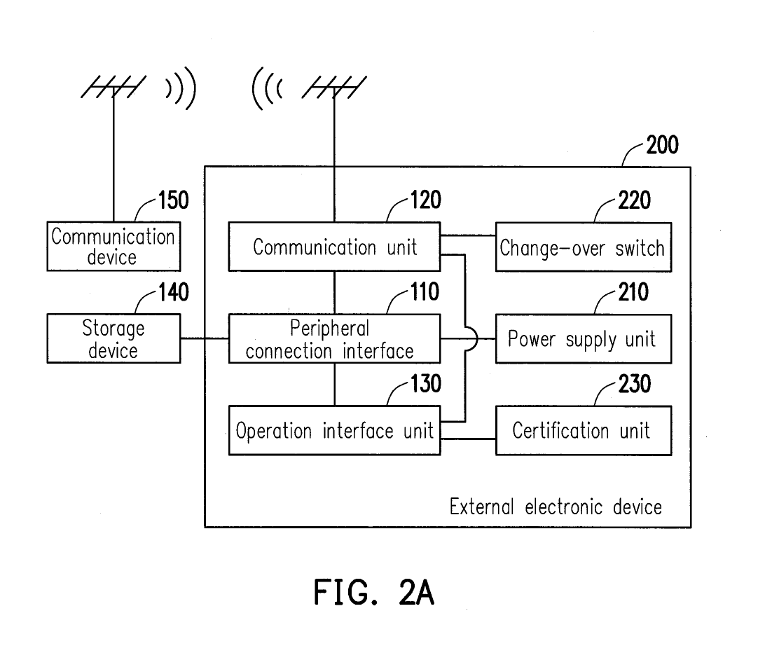

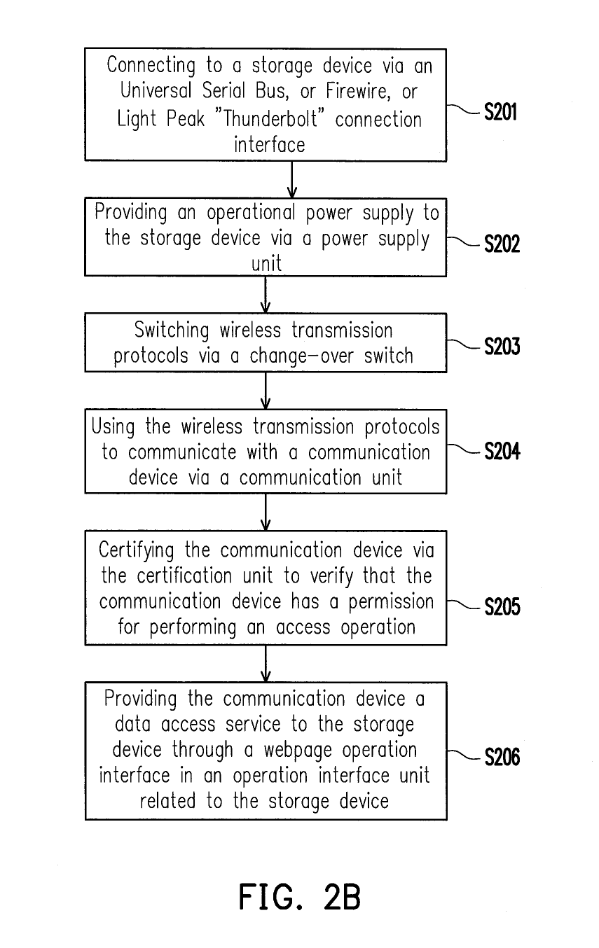

FIG. 2A illustrates a block diagram of establishing a wireless transmission between a storage device and a communication device via an external electronic device according to a second embodiment. In the present embodiment, an external electronic device 200, in addition to including the components of the external electronic device 100 in FIG. 1A, further includes a power supply unit 210, a change-over switch 220 and a certification unit 230. The power supply unit 210 is coupled to the universal serial bus, or firewire, or Light Peak “Thunderbolt” connection interface 110 for providing the operational power supply to the storage device 140 when the external electronic device 200 is connected to the storage device 140. The power supply unit 210 may be a battery, or an electronic component capable of converting electricity into a usable power source for the external electronic device 200.

The change-over switch 220 is coupled to the communication unit 120 for switching the wireless transmission protocol, so that the storage device 140 may perform a corresponding change-over when providing access service to the communication devices using different transmission protocols. For example, when the communication device 150 is a Smartphone using a 3G or 4G mobile network, and a distance between the communication device 150 and the storage device 140 is relatively distant, the change-over switch 220 may concurrently switch the storage device 140 to a 3G transmission protocol, so that the communication device 150 and the storage device 140 may communicate with each other via the 3G or 4G mobile network provided by the external electronic device 200. Since a billing method of the 3G or 4G mobile network is often related to an amount of data transferred, if the distance between the communication device 150 and the storage device 140 is applicable of using a Bluetooth transmission protocol, a wireless local area network protocol and other wireless communication protocol of short-range, the external electronic device 200 may switch the wireless transmission protocol into the Bluetooth transmission protocol via the change-over switch 220 so as to reduce a cost of data transfer and increase an efficiency of data transmission. Therefore, the external electronic device 200, via a configuration of the change-over switch 220, may perform a corresponding adjustment according to the transmission protocol used by the communication device 150, so that the storage device 140 has a greater flexibility when providing the wireless access service.

The certification unit 230 is coupled to the operation interface unit 130 for certifying the communication device 150 in order to verify that the communication device 150 has a permission for performing the access operation. For example, when the data within the storage device 140 has a privacy, through a configuration of the certification unit 230, the communication device 150 wanting to access the data within the storage device 140 is managed by using a method, such as account login or password entering. Therefore, the external electronic device 200 may protect the storage device 140 from being the data accessed by the communication device 150 without the permission, and thereby safeguards the privacy of the data privacy.

FIG. 2B schematically illustrates a flow chart diagram of providing a wireless access service via an external electronic device according to the second embodiment, the following combines the flow chart diagram of FIG. 2B to describe, in detail steps, a method for the external electronic device 200 to provide the wireless access service to the communication device 150.

Firstly, the external electronic device 200 is connected to the storage device 140 via the universal serial bus, or firewire, or Light Peak “Thunderbolt” connection interface 110 and the corresponding connecting interface of the storage device 140 (step S201), and in order to enable the storage device 140 to function normally, the external electronic device 200 provides the operational power supply to the storage device 140 via the power supply unit 210 (step S202). Next, in order to adapt to the communication devices 150 with different wireless transmission protocols, the external electronic device 200 switches all wireless transmission protocols in use via the change-over switch 220 (step S203), and then enable the wireless transmission protocols in use to communicate with the communication devices 150 via the communication unit 120 (step S204).

In order to manage the access of the communication device 150 of the storage device 140, the external electronic device 200 may certify the communication device 150 via the certification unit 230 to verify that the communication device 150 has the permission for performing the access operation (step S205). After the certification unit 230 uses the method, such as account login or password entering, to verify the access permission of the communication device 150, the external electronic device 200 may provide the communication device 150 the access service to the storage device 140 through the webpage operation interface, ios, and/or android operation interface unit in the operation interface unit 130 related to the storage device 140 (step S206).

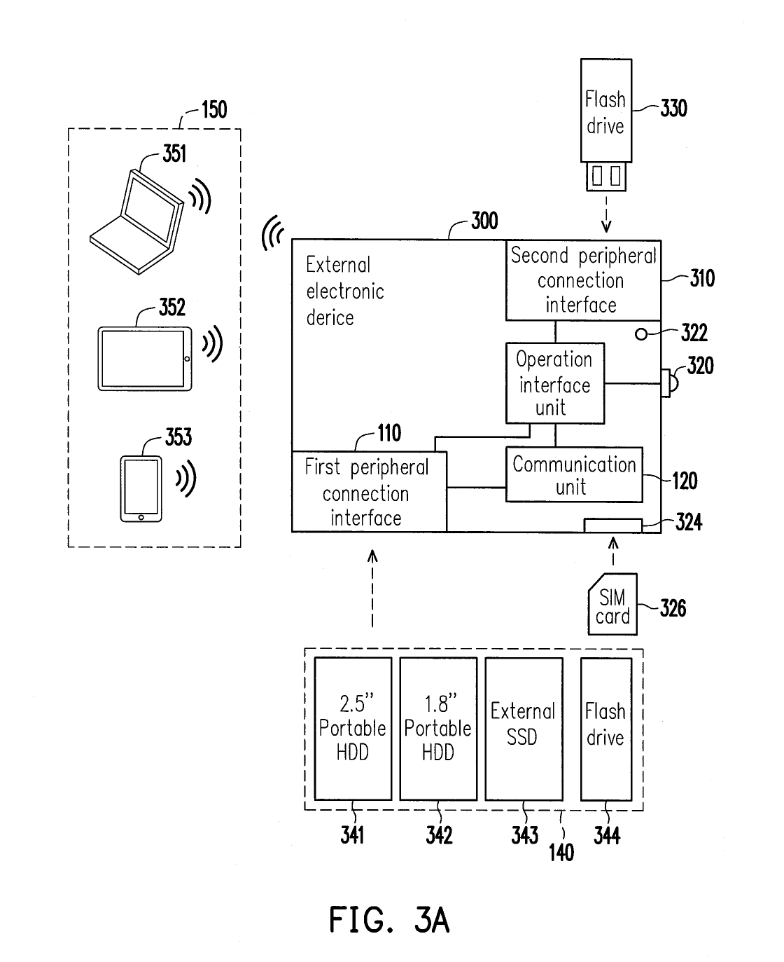

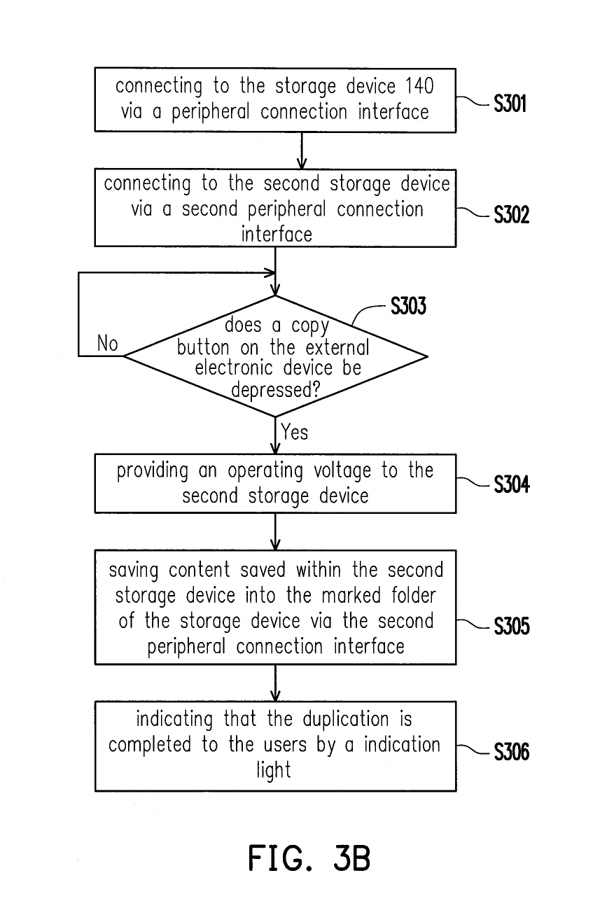

FIG. 3A illustrates a block diagram of establishing a wireless transmission between a storage device 140 and a communication device 150 via an external electronic device 300 according to a third embodiment. The difference between the external electronic device 300 of FIG. 3 and the external electronic device 100 of FIG. 1 is a second peripheral connection interface 310 and a copy button 320 are further included in the external electronic device 300. In addition, the communication unit 120 further includes a subscriber identification module(SIM) card slot 324 in order to use the SIM card 326, which is capable of providing a mobile internet service, to achieve a function of communication with the communication device 150.

The universal serial bus, or firewire, or Light Peak “Thunderbolt” connection interface 110 is referred to as a first peripheral connection interface 110, and the first peripheral connection interface 110 is connected to the storage device 140 (also referred to as a first storage device). For instance, The storage device 140 is a 2.5-inch portable hard drive 341, or a 1.8-inch portable hard drive 342, or a External solid state hard (SSD) drive 343, or a flash drive 344. The communication device 150 is notebook 351, or a laptop computer 352 , or a smart phone 353. The second peripheral connection interface 310 and the copy button 320 are coupled to the operation interface unit 130. the second peripheral connection interface 310 is connected to the second storage device (e.g., flash drive 330).

FIG. 3B illustrates a flow chart diagram of providing a access service via an external electronic device 300 according to the third embodiment. Please referring to FIGS. 3A and 3B, firstly, the external electronic device 300 is connected to the storage device 140 via the universal serial bus, or firewire, or Light Peak “Thunderbolt” connection interface 110 and the corresponding connecting interface of the storage device 140 (step S301). Then, the external electronic device 300 is connected to the second storage device (flash drive 330) via the second peripheral connection interface 310 (step S302).

While users want to duplicate and save a file from the second storage device (flash drive 330) to the storage device 140 connected to the external electronic device 300 via the first peripheral connection interface 110, the users depresses the copy button 320 on the shell surface of the external electronic device 300. By the copy button 320 is depressed, step 303 goes to step 304, and a power supply unit of the external electronic device 300 provides an operating voltage to the second storage device (flash drive 330) (step S304). The operation interface unit 130 establishes a marked folder in the storage device 140, consolidates all the content saved within the second storage device (flash drive 330) into the marked folder and saves it into the marked folder of the storage device 140. When the duplication of the operation interface unit 130 is made complete, the operation interface unit 130 indicates that the duplication is completed to the users by an indication light 322 (e.g., LED). Thus, the users can easily transfer data between the second storage device 330 and the storage device 140 by the above-mentioned functions without assistance of the computer devices.

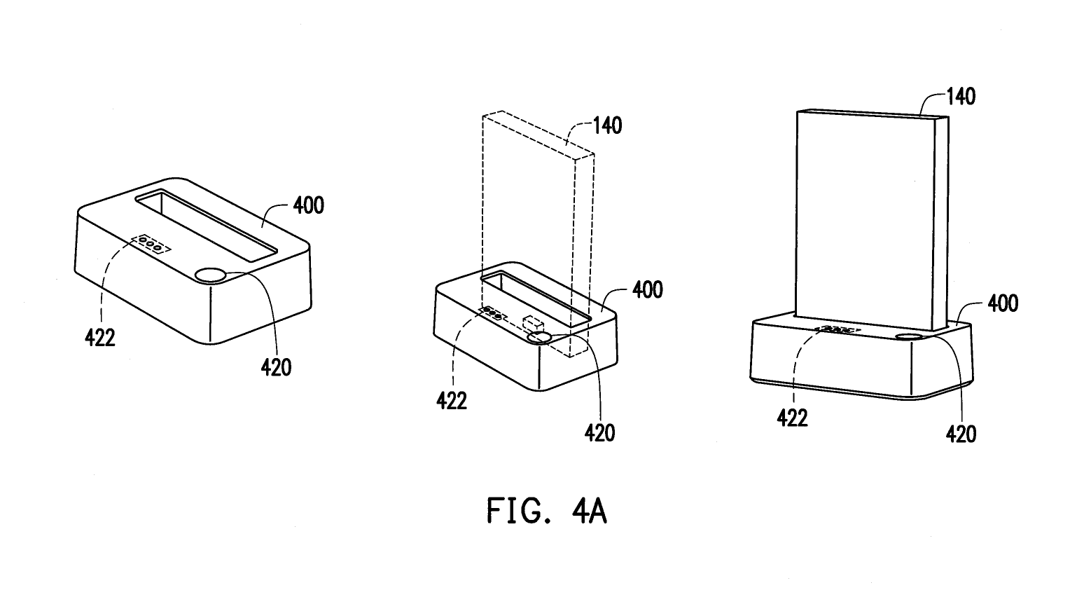

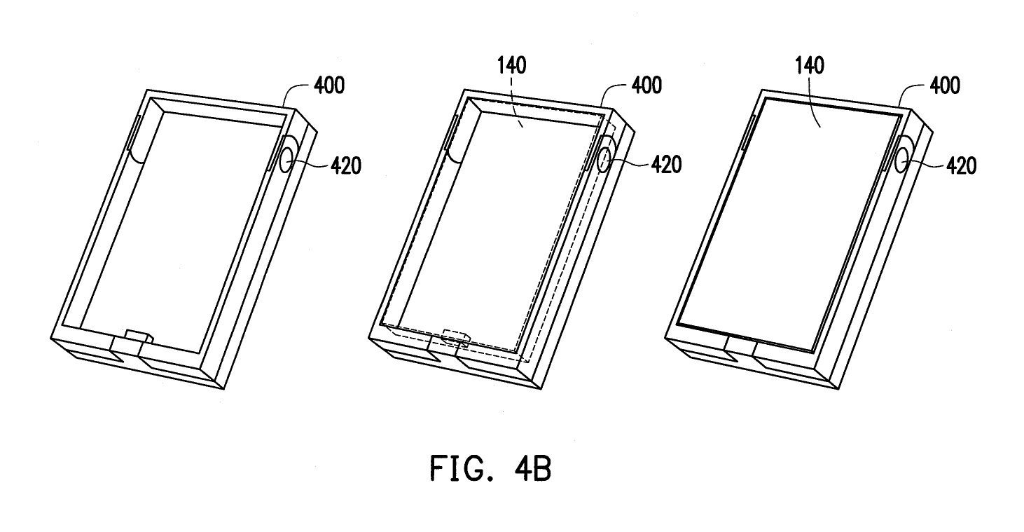

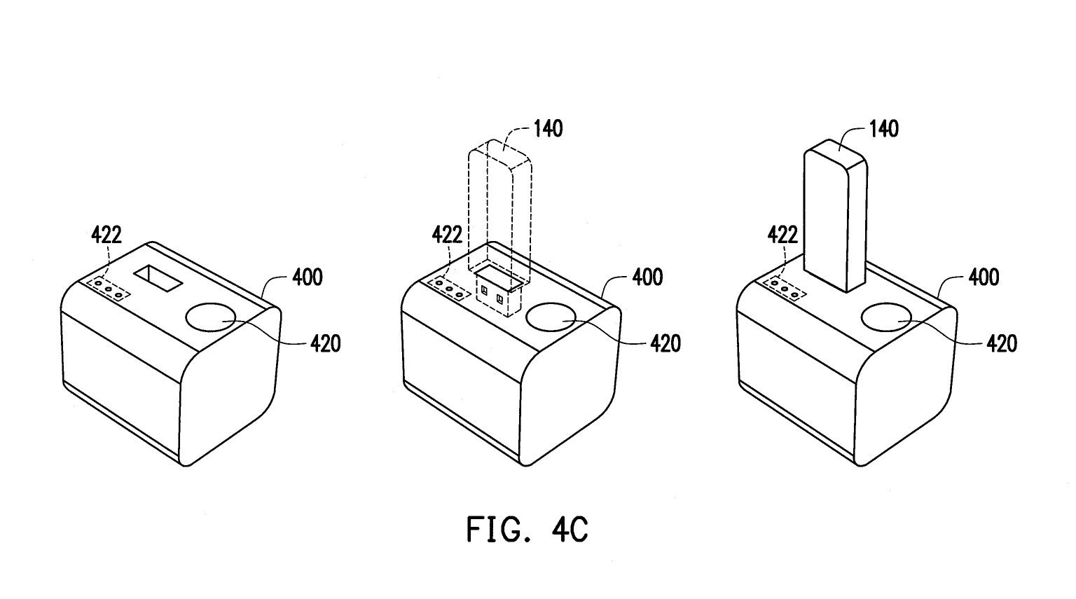

FIGS. 4A to 4C illustrate schematic structural diagram of an external electronic device 400 and a storage device 140. In FIGS. 4A to 4C, copy buttons 420 and indication lights 422 are set on the external electronic device 400. The form of the external electronic device 400 of FIG. 4A is set as a dock type, and the storage device 140 (e.g., portable hard drive) can be top-down insert to the external electronic device 400 of FIG. 4B so as to connected to each other. The form of the external electronic device 400 of FIG. 4B is set as a sleeve type, and the storage device 140 (e.g., portable hard drive) can be equipped with the external electronic device 400 of FIG. 4B. The form of the external electronic device 400 of FIG. 4A is also set as the dock type, and the storage device 140 with small size (e.g., flash drive with USB) can be top-down insert to the external electronic device 400 of FIG. 4A.

In summary, the invention provides the external electronic device and the method for providing the wireless access service thereof. In the embodiments of the invention, after the external electronic device is connected to the storage device with the universal serial bus, the communication device may use the wireless transmission protocol to communicate with each other via the wireless transmission interface established by the external electronic device, and may perform accessing and data management to, for example, the folder or the document within the storage device through the webpage operation interface. Therefore, a document transmission between the storage device and the communication device does not require any additional wiring connection, such that the communication device has more convenience when accessing the data within the storage device.

It will be apparent to those skilled in the art that various modifications and variations may be made to the structure of the invention without departing from the scope or spirit of the invention. In view of the foregoing, it is intended that the invention cover modifications and variations of this invention provided they fall within the scope of the following claims and their equivalents.

What is claimed is:

1. An external electronic device including:
a peripheral connection interface, connected to a storage device with a corresponding connecting interface;
a communication unit, coupled to peripheral connection interface and configured for communicating with a communication device via a wireless transmission protocol; and
an operation interface unit, coupled to the peripheral connection interface and the communication unit, wherein the operation interface unit has a webpage operation interface, ios application operation interface, and/or android application operation interface related to the storage device,
wherein, the external electronic device provides the communication device an access service to the storage device through the webpage operation interface.

2. The external electronic device as recited in claim 1, wherein the wireless transmission protocol comprises a Third Generation Mobile Telecommunication protocol, a Fourth Generation Mobile Telecommunication protocol, a Bluetooth protocol, a Wireless Fidelity certification protocol, or a wireless local area network protocol.

3. The external electronic device as recited in claim 2 further including a change-over switch coupled to the communication unit for switching the wireless transmission protocol.

4. The external electronic device as recited in claim 1 further including a power supply unit coupled to the peripheral connection interface for providing an operational power supply to the storage device.

5. The external electronic device as recited in claim 1 further including a certification unit coupled to the operation interface unit for certifying the communication device to verify that the communication device has a permission for performing an access operation.

6. The external electronic device as recited in claim 1, wherein the access service comprises read, edit, delete, and save.

7. The external electronic device as recited in claim 1, further including:
a second peripheral connection interface, coupled to the operation interface unit for connecting to a second storage device; and
a copy button, coupled to the operation interface unit, while the copy button are depressed, the operation interface unit establishes a marked folder in the storage device, and saves content saved within the second storage device into the marked folder of the storage device via the second peripheral connection interface.

8. A method for wirelessly accessing a storage device, suitable for an external electronic device, comprising the following steps:
connecting to a storage device via a peripheral connection interface;
using a wireless transmission protocol to communicate with a communication device via a communication unit; and
providing the communication device an access service to the storage device through a webpage operation interface, ios application operational interface, and/or android application operational interface in an operation interface unit related to the storage device.

9. The method for wirelessly accessing the storage device as recited in claim 8, wherein the wireless transmission protocol comprises a Third Generation Mobile Telecommunication protocol or Forth Generation Mobile Telecommunication protocol connection interface, a Bluetooth protocol, a Wireless Fidelity certification protocol, or a wireless local area network protocol.

10. The method for wirelessly accessing the storage device as recited in claim 9, wherein before the step of using the wireless transmission protocol to communicate with the communication device via the communication unit, further including:
switching the wireless transmission protocol via a change-over switch.

11. The method for wirelessly accessing the storage device as recited in claim 8, wherein after the step of connecting to the storage device via the peripheral connection interface, further including :
providing an operational power supply to the storage device via a power supply unit.

12. The method for wireless accessing the storage device as recited in claim 8, wherein before the step of providing the communication device the access service to the storage device through the operation interface unit, further including:
certifying the communication device via a certification unit to verify that the communication device has a permission for performing an access operation.

13. The method for wirelessly accessing the storage device as recited in claim 8, wherein the access service comprises read, edit, delete, and save.

14. The method for wirelessly accessing the storage device as recited in claim 8, further including:
connecting to a second storage device via a second peripheral connection interface;
setting a copy button; and
establishing a marked folder in the storage device, and saving content saved within the second storage device into the marked folder of the storage device via the second peripheral connection interface while the copy button is depressed.

15. An external electronic device including:
a first peripheral connection interface, connected to a first storage device with a corresponding connecting interface;
a second peripheral connection interface, connected to a second storage device with another corresponding connecting interface;
an operation interface unit, coupled to the peripheral connection interface and the communication unit; and
a copy button, coupled to the operation interface unit, while the copy button are depressed, the operation interface unit establishes a marked folder in the storage device, and saves content saved within the second storage device into the marked folder of the storage device via the second peripheral connection interface.
